(19) United States
(12) Patent Application Publication
(10) Pub. No.: US 2002/0175517 A1
(43) Pub. Date: Nov. 28, 2002

(54) Transparent MSRP label

(75) Inventor: Mike Anderson, Arvada, CO (US)

Correspondence Address: MERCHANT & GOULD PC, P.O. BOX 2903, MINNEAPOLIS, MN, 55402-0903, US

(73) Assignee: MSRPClear, Inc.

(21) Appl. No.: 09/927,485

(22) Filed: Aug. 10, 2001

Related U.S. Application Data
(60) Provisional application No. 60/293,892, filed on May 24, 2001.

(51) Int. Cl. B42D 15/00

(52) U.S. Cl. 283/81

(57) ABSTRACT

A manufacturer's suggested retail price (MSRP) label printed on transparent material, such that the text may be read, but the background is relatively clear. Once applied to a car window, the relatively clear background on the label allows a driver to see through a majority of the label and drive more safely.

### RELATED APPLICATIONS

This application claims priority of U.S. provisional application Serial No. 60/293,892, filed May 24, 2001.

### BACKGROUND OF THE INVENTION

1. Field of the Invention

This invention relates to the application of labels to motor vehicles and, in particular, the application of Manufacturer's Suggested Retail Price (MSRP) labels to vehicle windows.

2. Description of Related Art

When displaying a new or used motor vehicle at a vehicle dealership, most dealerships display a label on one of the windows of the vehicle indicating the price and features of the vehicle. In particular, new car dealers are required by Federal law to affix to a window of the car a label, often referred to as a “Monroney Sticker.” The Monroney sticker typically includes the base price of the vehicle, the manufacturer's installed options, the manufacturer's transportation charge, and the manufacturer's suggested retail price (MSRP). Additionally, for economy and convenience, other information is also typically included on the Monroney sticker. For example, the sticker may also include information related to the percentage of parts of the vehicle that were manufactured in the United States and the percentage of parts of the vehicle manufactures in foreign countries. The sticker may include information related to the fuel economy of the vehicle. For example, the sticker may include the Gas Mileage Guide for that vehicle, as distributed by the U.S. Department of Energy (DOE). As used herein, the term MSRP label will be used to indicate a sticker inclusive of the Monroney Sticker and any other information, such as that described above.

Given the quantity of information displayed, MSRP labels are fairly large. Indeed, the typical MSRP label is larger than a square foot in size. As such, MSRP labels typically occupy a significant portion of the window to which they are affixed.

In order to see the lettering on the MSRP label, the MSRP label is typically printed with dark type on a light-colored background. For example, the MSRP label is most often printed with black lettering on a white, opaque background composed of paper or other opaque material.

One drawback associated with the MSRP labels printed on an opaque material is that during a test drive of the car, the MSRP label may limit the driver's field of vision, thus causing a safety hazard. One solution to this problem is to place the MSRP label on a window, such as a rear passenger-side window, where the label will least limit the driver's field of vision. Unfortunately, the rear passenger-side windows of many vehicles are not sufficiently large to accommodate the MSRP label. Furthermore, many vehicles, such as some pick-up trucks, do not even have rear passenger-side windows.

When a vehicle does not have a sufficiently large rear window to accommodate an MSRP label, or when a vehicle does not have a rear passenger-side window, the MSRP label is often placed on a front passenger-side window or on a front driver-side window. Unfortunately, placement of the MSRP sticker on the front driver-side window or the front passenger-side window greatly limits the driver's field of vision, thus causing a safety hazard.

Additionally, with respect to some automobiles, such as convertibles, the MSRP label is typically placed on the windshield so that the convertible may be displayed with the windows down. However, the placement of the MSRP label on the windshield severely limits the driver's field of vision during a test drive, thus making it virtually impossible to test drive the convertible with the MSRP label in place.

Another solution to the above mentioned problems is to remove the MSRP label from the vehicle's window during the test drive. This practice, although safer than leaving the MSRP label in place, is not satisfactory, since the labels go through significant wear and tear during the continuous removal and replacement of the labels. Moreover, with respect to automobiles, Federal law prohibits the removal of the label prior to the delivery of the automobile to the ultimate purchaser. Such a requirement is difficult if not impossible to follow while test driving an automobile having prior art MSRP labels.

It is with respect to these and other problems that the present invention has been made.

### SUMMARY OF THE INVENTION

An embodiment of the present invention relates to an MSRP label printed on transparent material, such that the text may be read, but the background is relatively clear. Once applied to a car window, the relatively clear background on the label allows a driver to see through a majority of the label and drive more safely.

In accordance with certain aspects, an embodiment of the present invention relates to a label for displaying manufacturer's suggested retail price information for a motor vehicle on a window of the motor vehicle. In one embodiment, the label comprises a substantially transparent information sheet having the manufacturer's suggested retail price of the vehicle printed in text on the label, such that the text is visible through the window when the label is affixed to the window of the motor vehicle.

Another embodiment of the present invention relates to a label for displaying manufacturer's suggested retail price information for a motor vehicle on a window of the motor vehicle having a substantially transparent information sheet having text providing the manufacturer's suggested retail price information of the vehicle printed thereon, such that the text is visible through the window of the motor vehicle when the label is affixed to the window of the motor vehicle. Also include in this embodiment is a substantially opaque base sheet. The base sheet is formed from a material exhibiting static-cling properties, thereby permitting the base sheet to be removably affixed to the information sheet when the information sheet is affixed to the window of the motor vehicle.

Yet another embodiment of the present invention relates to a label for displaying manufacturer's suggested retail price information for a motor vehicle on a window of the motor vehicle having a substantially transparent information sheet having text providing the manufacturer's suggested retail price information of the vehicle printed thereon, such that the text is visible through the window of the motor vehicle when the label is affixed to an exterior surface of the window of the motor vehicle. Also include in this embodiment is a substantially opaque base sheet formed from a material exhibiting static-cling properties, thereby permitting the base sheet to be removably affixed in a position opposite the information sheet on an interior surface of the window when the information sheet is affixed to the exterior surface of the window.

A more complete appreciation of the present invention and its improvements can be obtained by reference to the accompanying drawings, which are briefly summarized below, to the following detail description of presently preferred embodiments of the invention, and to the appended claims.

### BRIEF DESCRIPTION OF THE DRAWINGS

FIG. 1 illustrates a prior-art, non-transparent MSRP label placed on a car window.

FIG. 2 illustrates an embodiment of the invention showing a transparent MSRP label placed on a car window.

FIG. 3 illustrates an information sheet of a transparent MSRP label in accordance with an embodiment of the invention.

FIGS. 4, 5, 6, and 7 illustrate alternative placement locations on a car for the MSRP label shown in FIG. 3.

FIG. 8 illustrates an information sheet of a transparent MSRP label in accordance with another embodiment of the invention.

FIG. 9 illustrates the placement on a window of the MSRP label shown in FIG. 8.

FIG. 10 illustrates an information sheet of a transparent MSRP label in accordance with another embodiment of the invention.

FIG. 11 illustrates the placement on a window of the MSRP label shown in FIG. 10.

### DETAILED DESCRIPTION

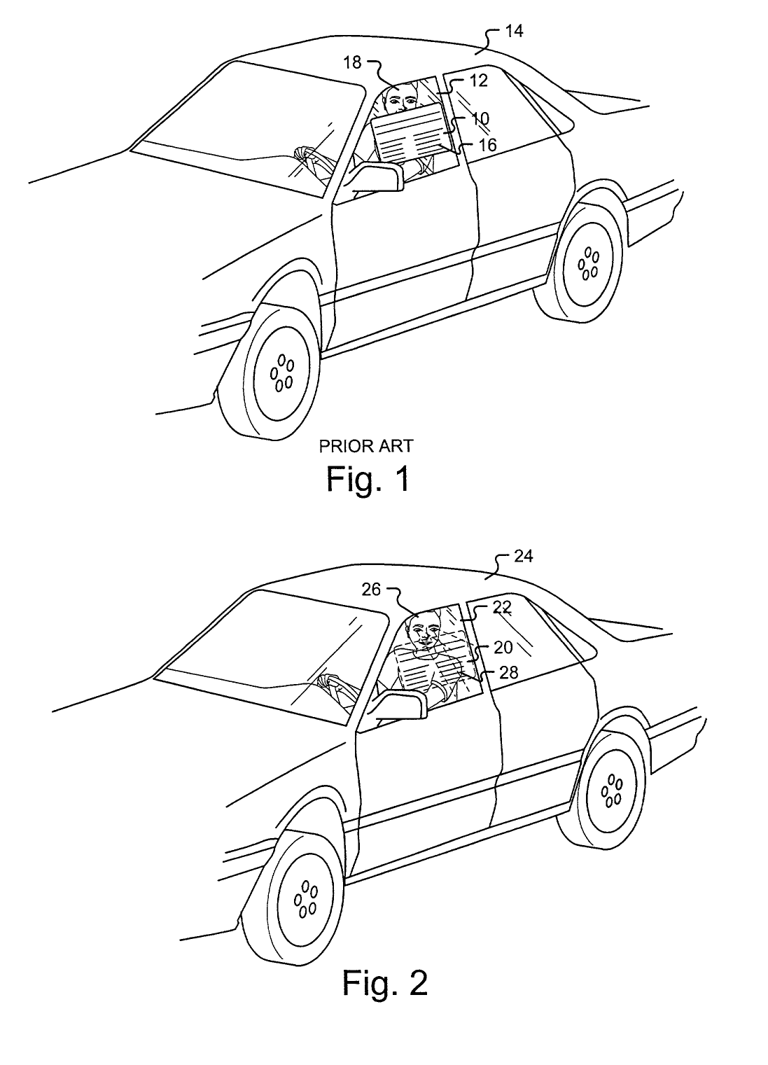

FIG. 1 illustrates a prior-art MSRP label 10 affixed on a window 12 of an automobile 14. As is typical, the MSRP label 10 has black or dark colored text 16 written on an white or light colored, opaque, contrasting background. As shown in FIG. 1, the MSRP label 10 occupies a significant portion of the window 12, thus limiting the field of vision of a driver 18 of the automobile 14.

FIG. 2 illustrates a transparent MSRP label 20 of the present invention positioned on a window 22 of an automobile 24. As shown in FIG. 2, the label 20 is placed on the driver-side window 22 of the automobile 24. However, as discussed below, the label 20 may be placed on any of the windows of the automobile 24. Furthermore, it is to be understood that the use of the label 20 is not limited to its use on automobiles, but may be used on any vehicle having a window sufficient in size to accommodate the label 20.

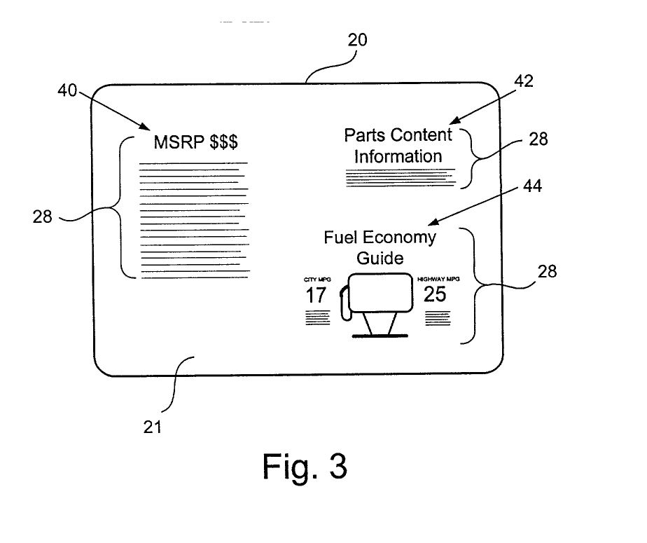

As shown in FIG. 3, the label 20 includes a information sheet 21 having text or writing 28 thereon. The information sheet 21 is composed of a substantially transparent material that allows clarity of vision through the base sheet 21, enabling the eye to focus on objects viewed through the base sheet 21. The label material may be made of many different transparent materials. In an embodiment, a relatively thin and flexible plastic or plastic-like material is used. This plastic material may be, without limitation, a static-cling type material designed to adhere to glass without the use of an adhesive, such as a vinyl static-cling type material formed from a polyvinyl chloride material. Alternative embodiments incorporating other materials may be used for the information sheet 21, so long as these materials are flexible enough to conform to the contour of a vehicle window, substantially transparent, and capable of being affixed to a vehicle window.

The text 28 is embedded in, or printed on, the information sheet 21 in a color that allows the text 28 to be visible when viewing the label when it is affixed to a window of a vehicle. As will be understood to one skilled in the art, any number of methods may be used to embed the text in, or print the text on, the label 20. For example, the text may be printed on the information sheet 21 by screen printing, offset lithography, flexographic printing, UV letter press, thermal transfer, etc.

The text 28 may be of a light color, such as white, so that the text will be contrasted against the dark or shaded interior of a vehicle when the text is viewed from outside of the vehicle. Alternatively, the text 28 may be of a dark color so that it is contrasted with a light vehicle interior. Indeed, many colors may be used on the transparent label. However, the color of the text 28 should be selected such that it is easily viewable from outside of the vehicle, but does not significantly impair the vision of a driver while driving the vehicle. In one embodiment the text 28 of the label 20 is white and the letters of the text are sufficiently small and well spaced, such that the vision of a driver of the vehicle is not excessively impaired when looking through the label 20.

The content of the text 28 on the label 20 may vary. However, with respect to the use of the label 20 on a new motor vehicle, the text will include information related to the manufacturer's suggested retail price 40. For example, the information related to the manufacturer's suggested retail price may be Federally mandated information related to the manufacturer's suggested retail price. The label 28 may also include information related to the percentage of parts of the vehicle that were manufactured in the United States and the percentage of parts of the vehicle manufactures in foreign countries 42. The label may also include information related to the fuel economy of the vehicle 44. For example, the information related to the fuel economy of the vehicle may include the Gas Mileage Guide, as distributed by the U.S. Department of Energy (DOE). In addition, the label may include other text, such as, without limitation, information related to other features of the vehicle, information related to the manufacturer of the vehicle, and/or information related to the sales or marketing of the vehicle.

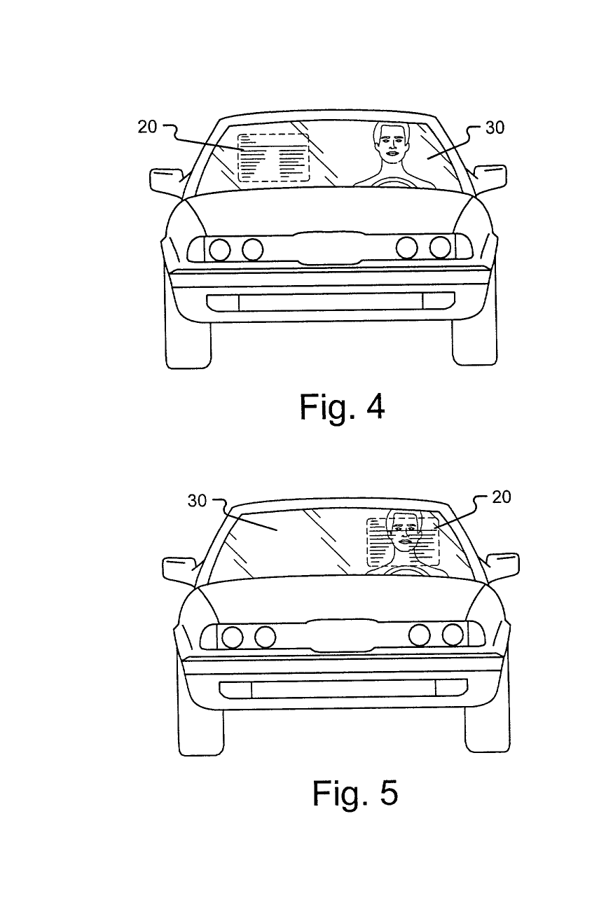

FIGS. 4 and 5 illustrate the label 20 shown on a windshield 30 of an automobile 24. Since the label is relatively transparent, the label may remain on the windshield, either on the passenger-side, as shown in FIG. 4, or on the driver-side, as shown in FIG. 5, while test driving the automobile. Although it is not preferred to have the driver drive the automobile while the label 20 is placed on the driver-side (FIG. 5), as the text is not transparent and may partially impair the driver's vision, the embodiment shown in FIG. 5 illustrates that the automobile may be driven with the label in this position.

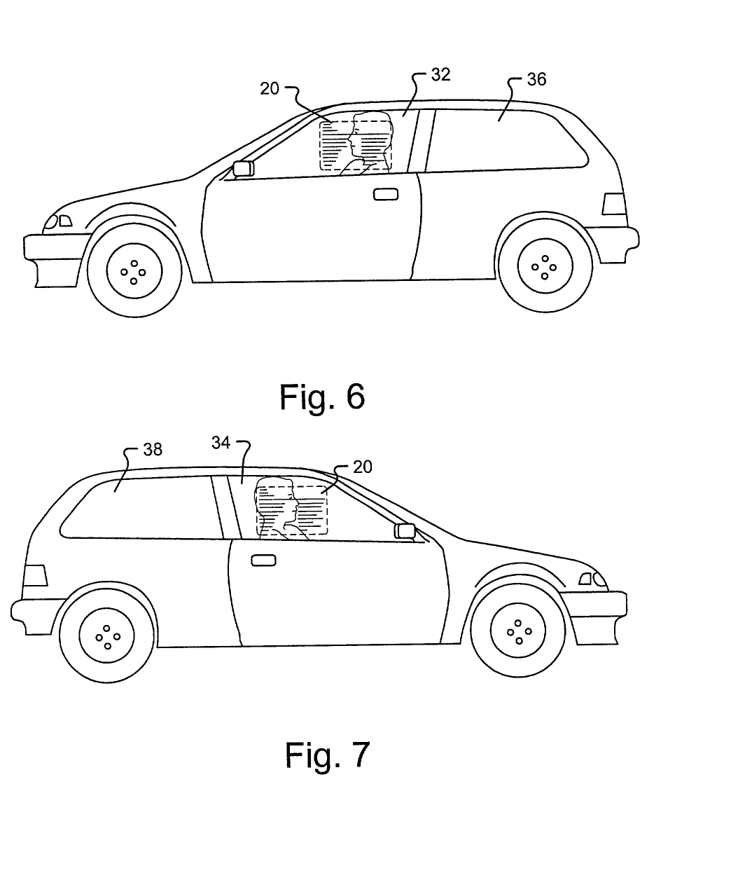

FIGS. 6 and 7 illustrate alternative placement locations for label 20. In FIG. 6, the label 20 is placed on the driver-side window 32, as in FIG. 2 described above. In FIG. 7, the label 20 is placed on the passenger-side window 34. Of course there are many other possible locations for the label 20 on a vehicle. Indeed, if the vehicle has other windows, such as windows 36 and 38 (FIGS. 6 and 7, respectively), then these locations may be preferred, as they may provide the least distracting location for the label 20. However, as described above, many vehicles do not have these windows, such that the other locations, depicted in FIGS. 4, 5, 6 and 7 may be used. Moreover, even when positioned in alternative locations, such as on windows 36 and 38 (FIGS. 6 and 7, respectively), the transparent nature of label 20 enables the driver to still substantially see through the windows 36 or 38 while driving.

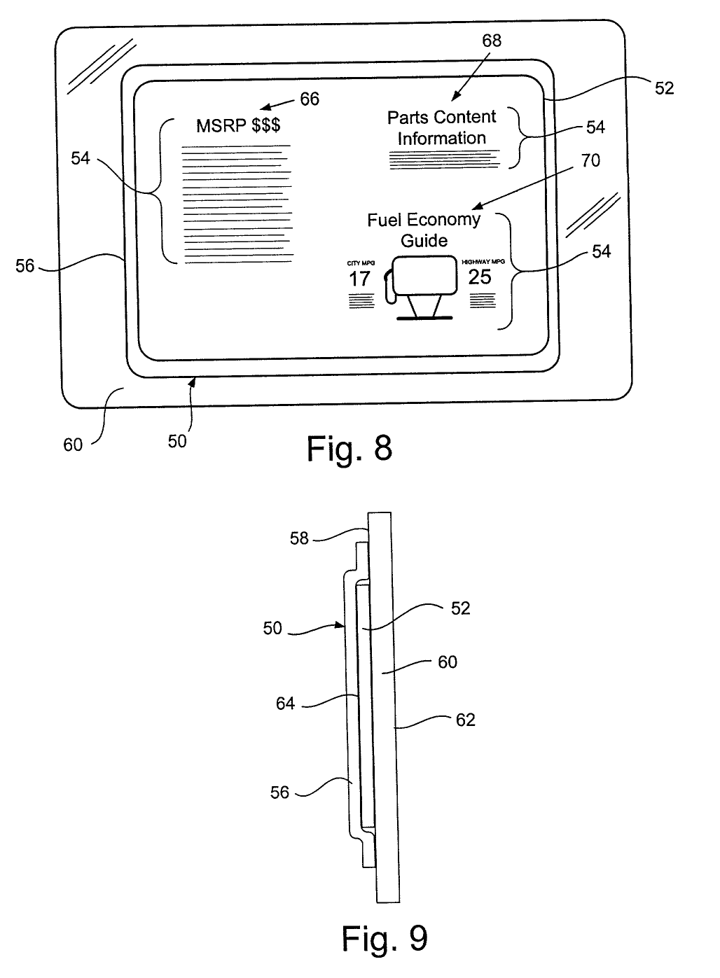

Another embodiment of the present invention is depicted in FIGS. 8 and 9. In this embodiment, a label 50 includes a flexible, predominantly transparent information sheet 52, including text 54 printed thereon, and a flexible, opaque base sheet 56. As shown in FIGS. 8 and 9, in one embodiment, the information sheet 52 is affixed to the interior surface 58 of a vehicle window 60, such that text 54 is visible through the window from an exterior surface 62 of the vehicle window 60. The opaque base sheet 56 is then removably affixed to the vehicle window 60 and a back surface 64 of the information sheet 52. Configured in this manner, the opaque base sheet 56 and the information sheet 52 may remain affixed to the vehicle window 60 when the vehicle is being displayed, thus providing optimal viewing of the text 54 of the information sheet 52. Then, when the vehicle is to be driven, the opaque base sheet 56 may be removed, leaving only the information sheet 52 on the vehicle window. In this way, the field of vision of a driver of the vehicle will be improved.

In this embodiment, the text 54 and the opaque base sheet 56 have different, contrasting colors, such that the text 54 “stands out” when viewed against the contrasting background of the opaque base sheet 56. For example, as shown in FIG. 8, the text 54 is black in color and the opaque base sheet 56 is white in color.

The information sheet 52 may be made of any number of different transparent materials. In one embodiment, a relatively thin and flexible plastic or plastic-like material is used. This plastic material may be, without limitation, a static-cling type material designed to adhere to glass without the use of an adhesive, such as static-cling vinyl. Alternative embodiments incorporating other materials may be used for the base, so long as these materials are flexible, substantially transparent, and capable of being affixed to a window. The text may be printed on the information sheet 52 by any number of processes, such as, without limitation, screen printing, offset lithography, flexographic printing, UV letter press, thermal transfer, etc.

The base sheet 56 may be made of any number of different opaque materials. In one embodiment, a relatively thin and flexible plastic or plastic-like material is used. This plastic material may be, without limitation, a static-cling type material designed to adhere to glass without the use of an adhesive, such as static-cling vinyl. Alternative embodiments incorporating other materials may be used for the base sheet 56, so long as these materials are flexible, substantially transparent, and capable of being affixed to a window.

The content of the text 54 on the label 50 preferably includes information related to the manufacturer's suggested retail price of the vehicle 66. The label 50 may also include information related to the percentage of parts of the vehicle that were manufactured in the United States and the percentage of parts of the vehicle manufactures in foreign countries 68. The label may also include information related to the fuel economy of the vehicle 70. For example, the information related to the fuel economy of the vehicle may include the Gas Mileage Guide, as distributed by the U.S. Department of Energy (DOE). In addition, the label may include other text 54, such as, without limitation, information related to other features of the vehicle, information related to the manufacturer of the vehicle, information related to the parts content of the vehicle, and/or information related to the sales or marketing of the vehicle.

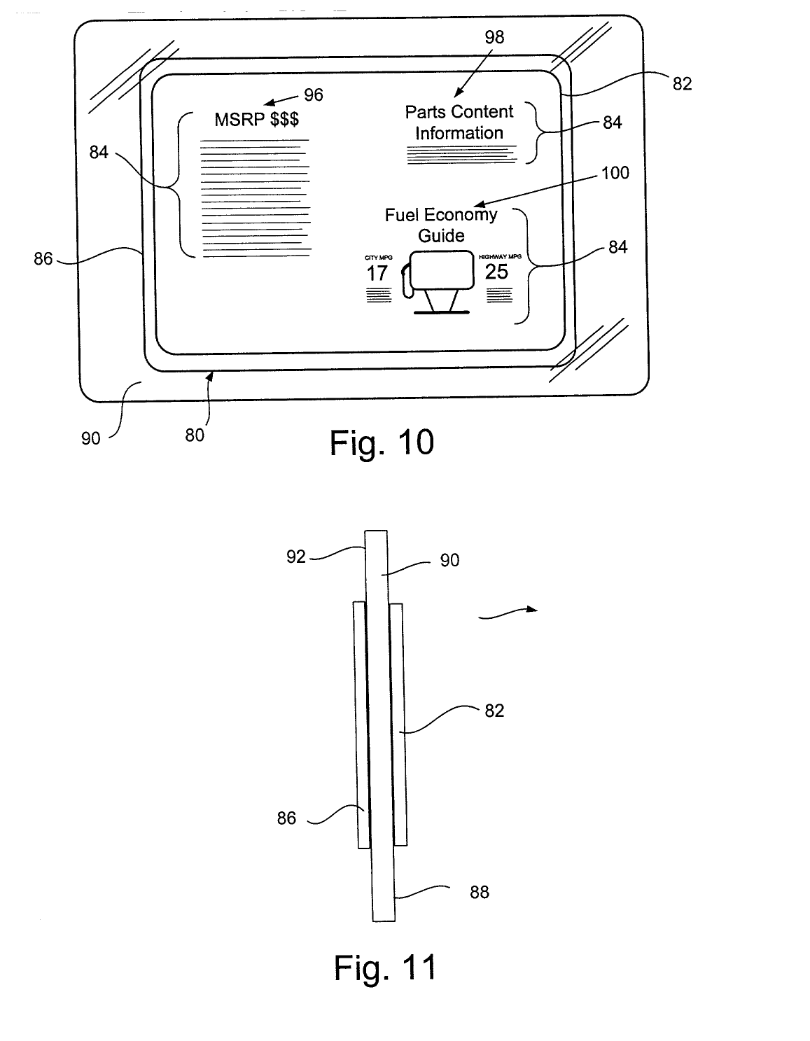

In an alternative embodiment of the present invention, shown in FIGS. 10 and 11, a label 80 includes a flexible, predominantly transparent information sheet 82, including text 84 printed thereon, and a flexible, opaque base sheet 86. In this embodiment, the information sheet 82 is affixed to the exterior surface 88 of a vehicle window 90, such that text 84 is visible on the exterior surface 88 of the vehicle window 90. The opaque base sheet 86 is then removably affixed to the interior surface 92 of the vehicle window 90. Configured in this manner, the opaque base sheet 86 and the information sheet 82 may remain affixed to the vehicle window 90 when the vehicle is being displayed, thus providing optimal viewing of the text 84 of the information sheet 82. Then, when the vehicle is to be driven, the opaque base sheet 86 may be removed from the interior surface 92 of the window 90, leaving only the information sheet 82 on the vehicle window. In this way, the field of vision of a driver of the vehicle will be improved.

The content of the text 84 on the label 80 preferably includes information related to the manufacturer's suggested retail price of the vehicle 96. The label 80 may also include information related to the percentage of parts of the vehicle that were manufactured in the United States and the percentage of parts of the vehicle manufactures in foreign countries 98. The label may also include information related to the fuel economy of the vehicle 100. For example, the information related to the fuel economy of the vehicle may include the Gas Mileage Guide, as distributed by the U.S. Department of Energy (DOE). In addition, the label may include other text 94, such as, without limitation, information related to other features of the vehicle, information related to the manufacturer of the vehicle, information related to the parts content of the vehicle, and/or information related to the sales or marketing of the vehicle.

The present invention significantly improves upon previous methods of displaying MSRP and other information on a vehicle. The present invention provides a way to display MSRP and other information on a vehicle without significantly limiting the field of vision of a driver of a vehicle. Thus, the MSRP label may remain on the vehicle during a test drive. Keeping the label on the vehicle during the test drive allows vehicle dealers to comply with requirements that the label not be removed until delivered to the ultimate purchaser, while providing a safer driving experience.

Various embodiments of the invention have been described with a degree of particularity. This description has been made by way of various examples. It should be understood that the scope of the present invention is defined by the following claims, and should not necessarily be limited by the detailed description of the various embodiments and examples set forth above.

We claim:

1. A label for displaying manufacturer's suggested retail price information for a motor vehicle on a window of the motor vehicle, said label comprising:
a substantially transparent information sheet; and
text on the information sheet, wherein the text provides manufacturer's suggested retail price information, the text visible through the window when said label is affixed to the window of the motor vehicle.

2. A label as defined in claim 1, wherein the information sheet is formed from a material exhibiting static cling properties, thereby permitting the base sheet to be removably affixed to the window of the motor vehicle.

3. A label as defined in claim 1, wherein the information sheet is formed from a flexible plastic material exhibiting static cling properties, thereby permitting the information sheet to be removably affixed to the window of the motor vehicle.

4. A label as defined in claim 3, wherein the information sheet comprises polyvinyl chloride.

5. A label as defined in claim 2, wherein the text is white in color.

6. A label as defined in claim 2, wherein the text provides information related to the motor vehicle's fuel efficiency.

7. A label as defined in claim 3, wherein the text provides information related to country of origin of manufacture of parts of the vehicle.

8. A label as defined in claim 2, wherein the text is printed on the information sheet.

9. A label as defined in claim 2, wherein the text is flexographically printed on the information sheet.

10. A label as defined in claim 2, wherein the text is screen printed on the information sheet.

11. A label for displaying manufacturer's suggested retail price information for a motor vehicle on a window of the motor vehicle, said label comprising:
a substantially transparent information sheet having text printed thereon, wherein the text provides manufacturer's suggested retail price information, the text visible through the window of the motor vehicle when the label is affixed to the window of the motor vehicle; and
a substantially opaque base sheet, formed from a material exhibiting static-cling properties, thereby permitting the base sheet to be removably affixed to the information sheet when the information sheet is affixed to the window of the motor vehicle.

12. A label as defined in claim 11, wherein the base sheet comprises polyvinyl chloride.

13. A label as defined in claim 11, wherein the information sheet comprises polyvinyl chloride.

14. A label as defined in claim 11, wherein the text provides information related to the fuel efficiency of the motor vehicle.

15. A label as defined in claim 13, wherein the text provides information related to country of origin of manufacture of parts of the vehicle.

16. A label for displaying manufacturer's suggested retail price information for a motor vehicle on a window of the motor vehicle, said label comprising:
a substantially transparent information sheet having text printed thereon, wherein the text provides manufacturer's suggested retail price information, the text visible when the label is affixed to an exterior surface of the window of the motor vehicle; and
a substantially opaque base sheet formed from a material exhibiting static-cling properties, thereby permitting the base sheet to be removably affixed in a position opposite the information sheet on an interior surface of the window when the information sheet is affixed to the exterior surface of the window.

17. A label as defined in claim 16, wherein the base sheet comprises polyvinyl chloride.

18. A label as defined in claim 16, wherein the information sheet comprises polyvinyl chloride.

19. A label as defined in claim 16, wherein the text provides information related to the fuel efficiency of the motor vehicle.

20. A label as defined in claim 16, wherein the text provides information related to country of origin of manufacture of parts of the vehicle.

21. A method of presenting information on a window of a motor vehicle, comprising the steps of:
printing information indicative of the manufacturer's suggested retail price of the vehicle on a sheet of substantially transparent, static-cling material; and
affixing the sheet on the window of the motor vehicle.

22. The method of claim 21, wherein the printing step further comprises printing the information on the sheet of substantially transparent, static-cling material using ink having a color that contrasts with the vehicle's interior color.

23. The method of claim 21, wherein the printing step further comprises printing the information on the sheet of substantially transparent, static-cling material using white ink.

24. The method of claim 21, wherein the printing step comprises flexographically printing the information on the sheet of substantially transparent, static-cling material.

25. The method of claim 21, wherein the printing step comprises screen printing the information on the sheet of substantially transparent, static-cling material.

26. The method of claim 21, wherein the sheet is affixed on the window using only the static-cling properties of the sheet of substantially transparent, static-cling material.

27. The method of claim 21, wherein the printing step further comprises printing information related to the motor vehicle's fuel efficiency on the sheet of substantially transparent, static-cling material.

28. The method of claim 27, wherein the printing step further comprises printing information related to related to country of origin of manufacture of parts of the vehicle on the sheet of substantially transparent, static-cling material.

29. A method of presenting information on a window of a motor vehicle, comprising the steps of:
affixing a first sheet of substantially transparent, static-cling material to an interior surface of the window of the motor vehicle, the first sheet having printed thereon in a first color information indicative of the manufacturer's suggested retail price of the vehicle; and
affixing a second sheet of substantially opaque, static-cling material of a second color to the interior surface of the window, such that the second sheet substantially covers the first sheet to provide a contrasting background for the information printed on the first sheet.

30. The method of claim 29, wherein the first color is white.

31. The method of claim 29, wherein the second color is white.

32. The method of claim 29, wherein the first sheet comprises polyvinyl chloride.

33. A label as defined in claim 29, wherein the second sheet comprises polyvinyl chloride.

34. The method of claim 29, wherein the first sheet further includes information related to the motor vehicle's fuel efficiency.

35. The method of claim 34, wherein the first sheet further includes information related to related to country of origin of manufacture of parts of the motor vehicle.

36. A method of presenting information on a window of a motor vehicle, comprising the steps of:
affixing a first sheet of substantially transparent, static-cling material to an exterior surface of the window of the motor vehicle, the first sheet having printed thereon in a first color information indicative of the manufacturer's suggested retail price of the vehicle; and
affixing a second sheet of substantially opaque, static-cling material of a second color to an interior surface of the window opposite the first sheet, such that the second sheet covers the first sheet to provide a contrasting background for the information printed on the first sheet.

37. The method of claim 36, wherein the first color is white.

36. The method of claim 36, wherein the second color is white.

38. The method of claim 36, wherein the first sheet comprises polyvinyl chloride.

39. A label as defined in claim 36, wherein the second sheet comprises polyvinyl chloride.

40. The method of claim 36, wherein the first sheet further includes information related to the motor vehicle's fuel efficiency.

41. The method of claim 36, wherein the first sheet further includes information related to related to country of origin of manufacture of parts of the motor vehicle.

42. The method of claim 36, wherein the first sheet is affixed on the window using only the static-cling properties of the sheet of substantially transparent, static-cling material.

43. The method of claim 42, wherein the second sheet is affixed on the window using only the static-cling properties of the sheet of substantially transparent, static-cling material.
